(19) United States
(12) Patent Application Publication
(10) Pub. No.: US 2020/0277036 A1
(43) Pub. Date: Sep. 3, 2020

(54) MOBILE CONTAINER-TANK MODULE

(71) Applicant: TECHNOLOG GMBH HANDELS- UND BETEILIGUNGSGESELLSCHAFT FUER TECHNOLOGIE, Hamburg (DE)

(72) Inventor: Helmut RADEBOLD, Herzhorn (DE)

(73) Assignee: TECHNOLOG GMBH HANDELS- UND BETEILIGUNGSGESELLSCHAFT FUER TECHNOLOGIE, Hamburg (DE)

(21) Appl. No.: 16/765,210

(22) PCT Filed: Nov. 28, 2017
(86) PCT No.: PCT/EP2017/080672

§ 371 Date: May 19, 2020

(51) Int. Cl. B63H 21/38; F02M 21/02

(52) U.S. Cl. CPC B63H 21/38; B63B 25/16; F02M 21/0218

(57) ABSTRACT

A mobile container-tank module for liquid gas as fuel for drive units or energy-generation units as consumers is provided, wherein at least one process device for vaporizing the liquid gas is present in the container-tank module. The claimed mobile container-tank module provides that all the process devices for processing the liquid gas for direct fuel delivery to the drive units or energy-generation units are integrated within the dimensions of the container-tank module, wherein the container-tank module further has connections for an external energy source, in particular for receiving process heat for the vaporization of liquid gas, and for delivering processed gas to the drive units and energy-generation units. For safety reasons, it is provided to arrange the integrated process devices in a protected manner in the container-tank module.

The invention relates to a mobile container-tank module for liquid gas as fuel for drive units or energy-generation units as consumers according to the preamble of claim 1.

Owing to increasingly strict regulations concerning environmental protection, it is desirable also in the propulsion of ships to move away from previous fuels such as heavy fuel oil or marine grade diesel and to use liquid gas as fuel for drive units and energy-generation units.

An example thereof is described in EP 2 607 224 A1. The fuel containers described therein for receiving LNG or LPG are filled with corresponding liquid gas and loaded onto the corresponding ship from the shore. On board the ship, the corresponding delivery line for the LNG is connected to a docking station which is connected to process devices, permanently positioned on board the ship, for processing the liquid gas via vaporizers, heaters or compressors, etc., in order subsequently to feed the gas to corresponding drive units.

The fuel container containing liquid gas that is used in this manner here serves substantially as a transport container for the liquid gas that is used, wherein the problems of connection of the fuel container to the corresponding docking station and in particular leakage problems in those regions persist. In addition, these fuel containers can be used only on-board ships which have stationarily arranged process devices.

Since considerations concerning the supply of liquid gas as fuel likewise apply in the case of other consumers which, for example, are permanently or movably installed on the shore, wherein the supply of power plants, locomotives or other land vehicles is included, it is also desirable to have available a complete mobile container-tank module for these areas.

A proposal in this direction can be found, for example, in KR 20130057322 A. Within the scope of this proposal there is recommended a container-tank module for liquid gas which is permanently connected to the actual tank and also has a vaporizer device within the transport frame of the container, which vaporizer device comprises a plurality of large heat exchangers connected one behind the other.

The mobile container-tank module described in that publication requires further process units at the outlet of the vaporizer in order to provide processing of the liquid gas for direct feeding to consumers. For example, external separators and compressors are required for the further processing of the liquid gas. These further process units are generally installed stationarily on a ship or as a permanently installed assembly group, for example in the case of land-based consumers such as power plants.

A direct delivery of gas as fuel for end consumers for drive units is therefore not possible with this proposed container-tank module.

Since the previously described container-tank module uses ambient air for the vaporization of LNG, it requires relatively large heat exchange surfaces, which inevitably take up an appreciable part of the container volume, so that the tank volume for LNG is considerably limited.

Other processing installations for liquid gas, in particular for ship operations, are known, for example, from DE 10 2007 008 723 A1 or DE 10 2009 002 578 A1. In these processing installations, the process devices such as vaporizers, heating devices, compressors, pumps and heat exchangers and the like are, however, arranged stationarily and therefore provided permanently on ships, in other vehicles or in power plants.

The examples of the previously mentioned stationary processing installations for liquid gas on the one hand involve safety problems, which are caused in particular by the transfer operations and the filling of LNG tanks stationarily provided on ships, for example, from the shore. Such LNG tanks stationarily installed on ships or in other vehicles can, however, also not be handled as flexibly and safely as a mobile container-tank module as is the object and concept of the present invention.

Accordingly, the object of the present invention is to provide a mobile container-tank module for liquid gas as fuel which ensures optimum safety in the various possible uses and furthermore permits high flexibility in terms of use, wherein particular consideration is to be given to its use on ships.

This object is achieved according to the invention in a mobile container-tank module by means of the features of claim 1.

Advantageous further developments of the invention are claimed in the dependent claims and explained further in the description.

A central idea of the invention is to be able to position a mobile container-tank module filled with the corresponding liquid gas in the vicinity of the drive units or energy-generation units that are to be supplied, and to be able to supply those units as directly as possible with the processed liquid gas as fuel, wherein the totality or all of the process devices for processing the liquid gas, in particular for vaporizing the liquid gas, for heating the gas, for compressing, for adjusting the pressure of and for conveying the gas, are provided as process devices integrated within the dimensions of the container-tank module. A connection of the container-tank module for an external energy source, especially for receiving process heat for vaporizing liquid gas, is here preferably present, as is a further connection for delivering the processed gas to the drive units and energy-generation units. The integrated process devices are designed and/or arranged in a protected manner, so that the immediate vicinity cannot be regarded as being at risk of explosion.

A further fundamental idea is to provide, instead of an external energy source, an integrated, internal energy source, in particular a heating device, in the manner of an auxiliary heating system in vehicles.

The previously mentioned concept therefore permits on the one hand a high flexibility in terms of fuel storage, in that, for example, a larger number of such mobile container-tank modules filled with liquid are arranged on a ship as close as possible to main and auxiliary units, in particular in the form of stackable containers. At the same time, such a mobile container-tank module makes it possible to avoid critical line connections, in particular for liquid gas, to units that are external to the container, since all the process devices and components required for processing the liquid gas are installed completely in the region of the tank, preferably beneath the tank, that is to say with very short line paths. The integrated process devices, such as vaporizers, heat exchangers, pumps, valves and such devices, are here accommodated in housings and/or boxes within the dimensions of the container-tank module, so that high safety standards are achieved.

The container-tank module is therefore also designed to be mobile and transportable, so that it is possible to carry out filling of the tank module preferably on shore at suitable liquid gas terminals or filling stations, so that the risk associated with handling cryogenic LNG, for example at −163° C., due to releasable couplings or flexible hoses as potential weak spots and danger points for leaks can be moved to the on-shore filling site.

The above term LNG or LPG here in principle also stands for liquefied gas or other vaporizable liquid fuels, which also include methanol.

The use of the mobile container-tank module is suitable not only for ships but also for other consumers such as power plants or stationarily installed drives, but also further mobile consumers such as locomotives and other land or water vehicles.

Advantageously, the cryogenic tank is in the form of an insulated pressure tank of cylindrical shape, wherein a suitable insulation for the cryogenic temperature of the liquid gas, for example a vacuum-superinsulation or polyurethane foam, is provided. Other forms of tank, for example a membrane tank, are also conceivable. However, pressure-loaded tanks have the advantage that, owing to their flexibility, longer downtimes can be provided, and an associated build-up of pressure also becomes tolerable.

The container-tank module is so designed that the required process components for controlling and monitoring the process sequences, such as, for example, the vaporization or compression of the liquid gas or the states of the liquid gas, are integrated in the container-tank module.

For vaporizing liquid gas, it is also possible to use energy sources such as, for example, electrically operated heating devices or fuel-operated heating devices as in vehicles, in particular known as auxiliary heating systems.

The integration of these components is to be understood as meaning that, on the one hand, the arrangement lies within the dimensions of the containers used, in particular of standard containers. Where required, it is also possible to use container dimensions and transport and frame structures which differ from standard containers.

This integrated positioning of the components also means, on the other hand, that the components such as valves, sensors, pumps, heat exchangers and the like are accommodated in as compact and miniaturized form as possible in housings which on the one hand provide mechanical protection for those components and on the other hand also function as a safety enclosure in the event of an accidental escape of LNG or gas from lines or connection elements. The housings are here advantageously configured to be gas-tight and suitable for cryogenic temperatures and so designed that the immediate environment can in principle be categorized as explosion-proof and not potentially explosive.

The housings are here preferably arranged beneath the LNG tank, so that feeding of the LNG by means of gravity is also ensured.

In the container-tank module, consideration is also given to the fact that preferably, at an end portal, which corresponds to an end face of the tank, the external connections of gas-carrying lines are for safety reasons provided in a separated manner, in particular also inside a housing, wherein the housing also serves to mechanically protect the high-quality coupling systems. These connections are not designed as through-connections and, as a result of this encapsulation, do not have to be secured by a second barrier, so that, in view of the leakage risk too, a danger zone in the region of which ignition sources must not be arranged is not formed. This eliminated ignition risk applies both to the components in question in the tank module and to the container-tank module as a whole at the site of use.

The safety aspects also have the result that, at the opposite end to the previously mentioned end portal of the tank, that is to say on the other side of the tank module, outside the potentially explosive region, there are arranged one or further housings or boxes for receiving electrical and electronic components and also plug-type connectors for power, signal and control lines for external connection. The container-tank module has self-supporting properties conventional in containers and has end portals with corner fittings which are provided for the mounting, stowage and lashing of the tank module, with or without liquid gas, for transport of the tank module on land and sea.

If required by the installation and use, the lines and connections arranged at end portals in side regions or in the upper and lower region of the container-tank module can, for safety reasons, be provided with as great a distance as possible between gas-carrying lines and electrical components.

The container-tank module can also be equipped with wireless transmission means, in particular for GPS tracking, so that location tracking from the filling station of the tank module to the site of use, for example on a ship, can be carried out.

Further wireless transmission means can advantageously also be provided for data transfer for the monitoring and control of parameters of the container-tank module, such as, for example, pressures, temperatures, fill levels in the tank or in the case of the process sequences and the control thereof.

The container-tank module is preferably also so designed that it is able to communicate bidirectionally via a suitable data interface with the gas-consuming drive units or energy-generation units or the consumers, in order to receive requirements of the consumer, such as, for example, energy requirement in terms fuel or fuel specification, and to control the corresponding sequences.

The container-tank module has connection points for the supply of gas to the consumer or consumers and also for receiving process heat, in particular for LNG vaporization, wherein cooling water from combustion engines or in some cases sea- or ground-water, the latter in the case of land-based installations, can also be used. Connection points for emergency and safety systems are also present or can be retrofitted, for example an overpressure blow-off device for gas or also flushing, extinguishing or cooling water for cases of fire fighting.

The container-tank module according to the invention therefore provides the possibility of implementing both the storage of liquid gas such as LNG and also all the process technology equipment required for processing the liquid gas in a single module, so that risks of accident during the transport and other handling of cryogenic liquid gas, which carries risks at the site of use, such as a ship, can be minimized.

Other alternative solutions which have been considered for the processing of liquid gas as fuel for consumers, in particular for ships, in which a second module, which comprises the process technology equipment for processing LNG, is coupled with a tank-container, or process technology equipment stationarily installed on ships, always have the disadvantages that connections, which carry risks, have to be made in order to transfer the cryogenic LNG, and therefore prove to be unsatisfactory solutions.

Since all the process components and devices are provided in a system-integrated manner in the one container-tank module, complex installation and maintenance in the processing path of the liquid gas to the consumer are also unnecessary.

The container-tank module is advantageously equipped with a standardized interface, so that the container-tank module can be used on very different types of ship. This standardized interface also allows all information, including control and monitoring, to be entered in data processing systems present with the user. This is true, for example, also for the ship's own system for communication on and with the bridge, but also for a central power-generating facility of a power plant.

The standardized interface also allows a plurality of container-tank modules to be combined in cases where it is necessary to increase the storage and provisioning capacity.

The concept according to the invention of the container-tank module therefore offers the advantage of accurate position fixing of each individual container-tank module. By transmitting physical status data of process components and devices, remote diagnosis of process components and process states and remote control of those processes are also possible.

The invention will be explained in greater detail hereinbelow by means of two schematic drawings and their possible use. In the drawings:

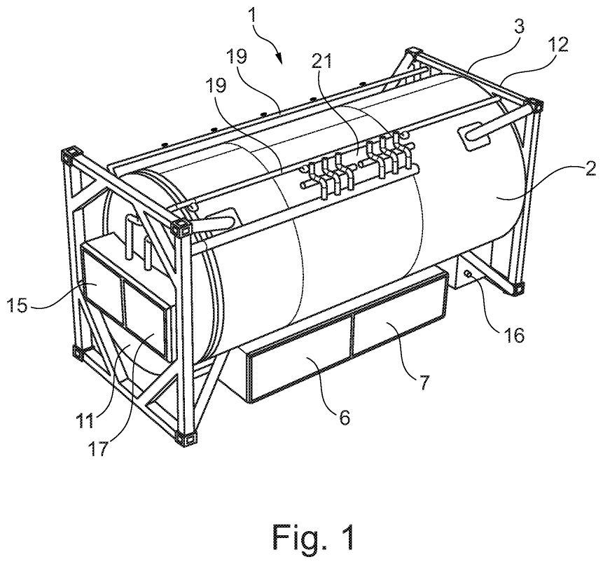

FIG. 1 is a simplified representation of a mobile container-tank module in a perspective view inside a transport frame with standard dimensions for containers; and

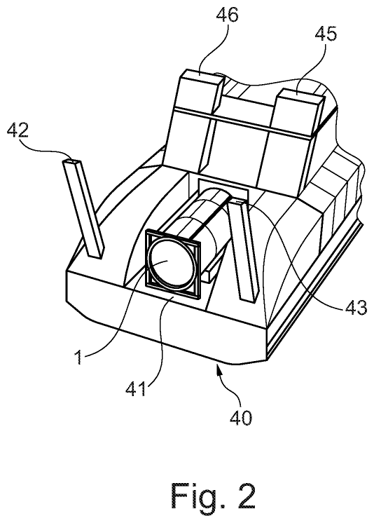

FIG. 2 shows a stern section of a ship he possibility of arranging a mobile container-tank module.

The schematic and simplified representation according to FIG. 1 shows a perspective view of a container-tank module 1, which has a substantially cylindrical pressure tank 2 which is permanently arranged inside a transport frame 3 of standard dimensions. The pressure tank 2, which receives a liquid gas such as LNG, LPG or methanol, is equipped with a heat-insulating jacket in order, for example, to be able to insulate the temperature of the liquid gas LNG relative to the outside temperature at about −163° C.

The transport frame 3 of the container-tank module 1 can preferably have standard dimensions of conventional containers of about 40′ (feet) or 20′ (feet) in length.

The container-tank module 1 is so designed that all the process devices for processing the liquid gas for direct fuel delivery to drive units or energy-generation units can be integrated and accommodated within the dimensions of the container-tank module 1 with the transport frame 3.

The process devices can here include in particular, for example, heat exchangers for vaporizing the liquid gas, heating devices for heating the gas, compressors for compressing and adjusting the pressure of the gas, or pumps for conveying the gas, but also valves or control modules. These process devices are installed in compact, miniaturized form in housings 6, 7 or boxes 15, 16, 17. The gas-carrying lines in particular are here accommodated in gas-tight housings 6, 7 which can be mechanically loaded and in particular, where necessary, are explosion-proof.

The housing or housings 6, 7 serve on the one hand as mechanical protection for the process devices and components and on the other hand have the function of a safety enclosure in the event of the accidental escape of LNG or gas from lines, connection elements or components such as valves, sensors, pumps and heat exchangers. Furthermore, these housings prevent the immediate environment from having to be categorized as potentially explosive and having to be correspondingly equipped.

Advantageously, the housings 6, 7 and the integrated process devices thereof are arranged beneath the cryogenic tank 2, so that the feeding of liquid gas downwards by means of gravity into corresponding process devices is also ensured.

In the left-hand region of FIG. 1, the approximately circular closing face of the pressure tank 2 is shown as the end portal 11. In the example, connection boxes 15 and 17 are provided in this region within the container dimensions. The connection box 15 can accommodate, for example, the connection to an external heat energy source. The connection box 17 can be provided for connection points for emergency and safety systems such as, for example, an overpressure blow-off device for gas or for flushing, extinguishing or cooling water. The boxes 15, 17 are normally designed to be gas-tight and capable of withstanding high mechanical loads.

On the right-hand side of the cryogenic pressure tank 2 there is the opposite end portal 12, in the region of which preferably one or more connection boxes 16 for electrical and electronic control and monitoring devices are installed. The connection box 16 is here purposively arranged at a greater distance from the housings 6, 7 or the boxes 15, 17, in order to be able to rule out any risk of explosion.

In the upper region of the pressure tank 2, monitoring fittings 21, for example valves and other systems, are further shown. Lines 19 are likewise provided on both sides of the pressure tank 2, which lines have nozzles for extinguishing and cooling water.

The mobile container-tank module according to the invention is suitable in particular for use on ships because the entire conversion and processing of the liquid gas such as LNG can be delivered in the form of heated and compressed gas directly to drive units or energy-generation units. The shortest possible line paths are taken into consideration here, since all the process devices for processing of the liquid gas are integrated within the dimensions of the chosen standard container.

FIG. 2 shows, schematically and in simplified form, the stern section 40 of a ship. In the middle of the stern there is in the example an open platform 41 for a mobile container-tank module 1, on which the container-tank module 1 can be positioned in a fixed and secure manner. 45, 46 denote exhaust gas chimneys of engines of the ship. The line connections for the delivery of processed gas to the consumers of the ship over short distances would be directed to the front in the example.

There are additionally shown in FIG. 2 on the stern an air inlet mast 42 on the port side and a blow-off mast 43 or a mast for letting out air on the starboard side.

The container-tank module 1 can therefore be regarded as a compact energy supply module for gas as fuel, which contains all the process technology equipment for processing liquid gas to gas and thereby in particular requires only a connection for an external energy or heat source and a delivery connection for the processed gas for direct feeding to consumers. Critical connections and couplings for liquid gas such as LNG can be avoided completely.

1.-9. (canceled)

10. Mobile container-tank module
a) for liquid gas as fuel for drive units or energy-generation units as consumers,
b) having at least one process device provided in the container-tank module for vaporizing the liquid gas,
c) wherein the container-tank module has a connection for an external energy source or an integrated energy source, for vaporizing liquid gas,
d) wherein at least one connection is provided for delivering processed gas to the drive units and energy-generation units,
e) wherein the integrated process devices are arranged in the container-tank module in a protected manner, and
f) wherein the process devices are provided in housings and/or boxes within the dimensions of the container-tank module,
characterized in that
g) all the process devices for processing the liquid gas for direct fuel delivery to the drive units or energy-generation units, in particular for vaporizing the liquid gas, for heating the gas, for compressing, for adjusting the pressure of and for feeding the gas, are provided as process devices integrated within the dimensions of the container-tank module
h) the housings are provided within the dimensions of the container-tank module beneath its cryogenic tank,
i) the external connections of gas-carrying lines are provided enclosed in a box at an end portal of the container-tank module, and
j) at least one box for receiving electrical and electronic components, and plug-type connections to external connections is provided at the opposite end portal.

11. Container-tank module according to claim 10,
characterized in that
the cryogenic tank, in particular an insulated pressure tank, for LNG, LPG or other vaporizable liquid fuels, such as, for example, methanol, is provided.

12. Container-tank module according to claim 10,
characterized in that
the required process components for controlling and monitoring the process sequences, such as vaporization or compression of the liquid gas, and the states of the liquid gas are integrated in the container-tank module.

13. Container-tank module according to claim 10,
characterized in that
wireless transmission means for GPS tracking of the container-tank module and for data transfer for monitoring and controlling of parameters of the container-tank module and the process sequences are provided.

14. Container-tank module according to claim 10,
characterized in that there is provided an interface or communication device with the consumers, in order to bidirectionally exchange requirement parameters, such as energy requirement in terms of fuel or fuel specification.

15. Container-tank module according to claim 10,
characterized in that the housings and/or boxes are designed to be gas-tight and suitable for cryogenic temperatures.

16. Container-tank module according to claim 10,
characterized in that for the vaporization of the liquid gas, a device having compact tubular or plate heat exchanger is provided, and
in that external process heat, such as cooling water from combustion engines or in some cases sea- or groundwater, is fed to the device.

17. Container-tank module according to claim 10,
characterized in that
the delivery pressure of the vaporized liquid gas, in particular of LNG, to consumers is set at a pressure level of from approximately 5 to not more than 10 bar.

18. Container-tank module according to claim 10,
characterized in that
the integrated heating device for the vaporization of liquid gas is designed in the manner of an auxiliary heating system for vehicles.
